(19) United States
(12) Patent Application Publication
(10) Pub. No.: US 2016/0156756 A1
(43) Pub. Date: Jun. 2, 2016

(54) COMMUNICATION DEVICE

(71) Applicant: KABUSHIKI KAISHA TOSHIBA, Tokyo (JP)

(72) Inventors: Ippei KASHIWAGI, Tokyo (JP); lsao OHBA, Tokyo (JP)

(73) Assignee: KABUSHIKI KAISHA TOSHIBA, Tokyo (JP)

(21) Appl. No.: 14/858,679

(22) Filed: Sep. 18, 2015

Related U.S. Application Data
(60) Provisional application No. 62/085,398, filed on Nov. 28, 2014.

(51) Int. Cl. H04M 1/02; H01Q 1/24

(52) U.S. Cl. CPC H04M 1/0266; H01Q 1/24

(57) ABSTRACT

According to one embodiment, a communication device includes a touchpanel includng a rectangular area on which electrodes are arranged, a first corner, a second corner opposite to the first corner, a third corner, and a fourth corner opposite to the third corner, a plurality of control lines connected to the respective electrodes and arranged to circumvent the area, a controller provided in a position closest to the first corner among the first, second, third and fourth corners, and configured to receive input to the electrodes via the plurality of control lines, and an antenna provided in a position closest to the second corner among the first, second, third and fourth corners.

### CROSS-REFERENCE TO RELATED APPLICATIONS

This application claims the benefit of U.S. Provisional Application No. 62/085,398, filed Nov. 28, 2014, the entire contents of which are incorporated herein by reference.

### FIEID

Embodiments described herein relate generally to a communication device.

### BACKGROUND

The production of communication devices comprising touchpanels has been developing. A touchpanel is used in combination with the liquid crystal panel and configured in such a manner that, when the user touches a predetermined position on the touchpanel based on the information displayed on the liquid crystal panel, an instruction is input into the communication, device.

A touchpanel has, for example, the following structure. The touchpanel comprises electrodes arranged in a matrix. Further, the electrodes are arranged in the communication device in such a manner as to correspond to dots of the liquid crystal panel. Still further, the electrodes are connected to a control board of the touchpanel via control lines. The control board is configured to detect input based on change in the voltage of the control lines. With such a configuration, the touchpanel detects input from the user.

Meanwhile, the control lines connected to the respective: electrodes of the touchpanel need to be laid at predetermined intervals to transmit voltage change to the control board without being influenced by other control lines. Therefore, it is necessary to provide a certain wiring width for arranging the control lines.

Further, the communication device needs to be provided with an antenna for performing communication with an external device. However, if the antenna is provided in vicinity to the above-described control lines, the radio waves transmitted and received by the antenna are interfered with by the control lines, and consequently the performance of the antenna deterlorates.

Such problem can be prevented simply by arranging the antenna and the control lines apart from each other. However, if a certain distance is still provided between the lines and the antenna in addition to the wiring width required as described above and the width of the antenna, the margin of the communication device widens. If the width of the margin increases, the communication device deteriorates in design and increases in size.

Therefore, there are demands for such a technique as to prevent the deterioration of the performance of the antenna and to narrow the margin of the communication device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an example of the main structure of the communication device of the first embodiment.

FIG. 2 is a schematic diagram for explaining an example of the projected capacitive method of the first embodiment.

FIG. 3 is a sectional view taken along A-A of FIG. 1.

FIG. 4 is a diagram showing an example of the main structure of the communication device of the second embodiment.

### DETAILED DESCRIPTION

Various embodiments will be described hereinafter with reference to the accompanying drawings.

In general, according to one embodiment, a communication device comprises: a touchpanel comprising a rectangular area on which electrodes are arranged, a first corner, a second corner opposite to the first corner, a third corner, and a fourth corner opposite to the third corner; a plurality of control lines connected to the respective electrodes and arranged to circumvent the area; a controller provided in a position closest to the first corner among the first, second, third and fourth corners and configured to receive input to the electrodes via the plurality of control lines; and an antenna provided in a position closest to the second corner among the first, second, third and fourth corners.

In the present specification, some elements are expressed in different ways. Note that these expressions are presented by way of example only and not intended to deny that there may be other ways of expressing the above-described elements.

Further, other elements not expressed in different ways may be expressed in other ways as well.

Still further, the drawings are schematic diagrams, and the relationship between the thickness and the other two dimensions, the ratio of the thicknesses of respective layers, and the like shown therein may be different from those of the embodied. Still further, the drawings may contain a portion in which the relationship or the ratio of the dimensions between the drawings is different from each other.

Various embodiments will be described hereinafter with reference to accompanying drawings.

### First Embodiment

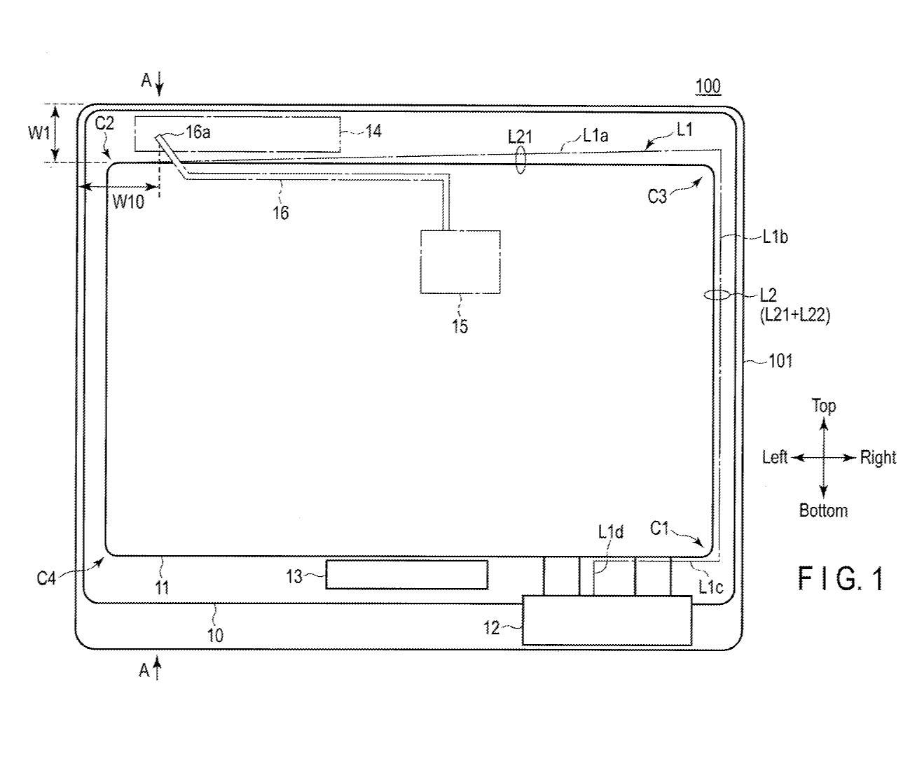

FIG. 1 is a drawing showing an example of the main structure of a communication device 100 of the first embodiment. More specifically, FIG. 1 is a top plan view for explaining an example or the relative arrangement of an antenna unit 14 and a control board 12. Further, in the present specification, the vertical and horizontal directions are defined as shown in the drawing. Note that the communication device 100 comprises, for example, a detachable notebook computer display, and that the display is realized as a notebook computer, a tablet computer or the like which can be used alone.

The communication device 100 comprises, as shown in FIG. 1, a housing 101. The communication device 100 further comprises a touchpanel glass 10 as a touchpanel, the control board 12 as a controller, an input interface 13, a plurality of control lines L2 including a control line L1, the antenna unit 14, a wireless module 15 as a wireless circuit, and a feed cable 16 as a power cable. The touchpanel glass 10, the control board 12, the input interface 13, the antenna unit 14, the wireless module 15 and the feed cable 16 are incorporated into the housing 101.

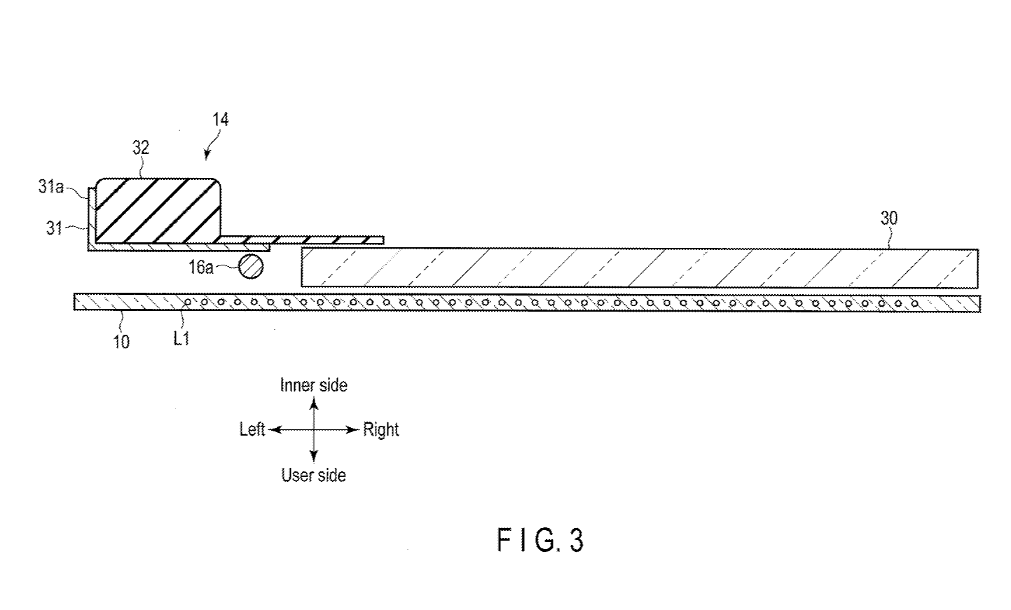

The touchpanel glass 10 is provided on the user side with respect to a liquid crystal panel 30 (see FIG. 3, which will be described later). Further, in the touchpanel glass 10, a rectangular active area 11 is formed in a size smaller than that of the touchpanel glass 10. The active area 11 is provided with a plurality of electrodes (switches) arranged in a predetermined array (which will be described later). Still further, the active area 11 being rectangular comprises four corners. More specifically, the active area 11 comprises a first corner C1 at the lower right corner, a second corner C2 opposite to the first corner C1, a third corner C3 at the upper right corner, and a fourth corner C4 opposite to the third corner C3. Still further, the active area 11 comprises one side on the upper side. The one side comprises the second corner C2 and the third corner C3.

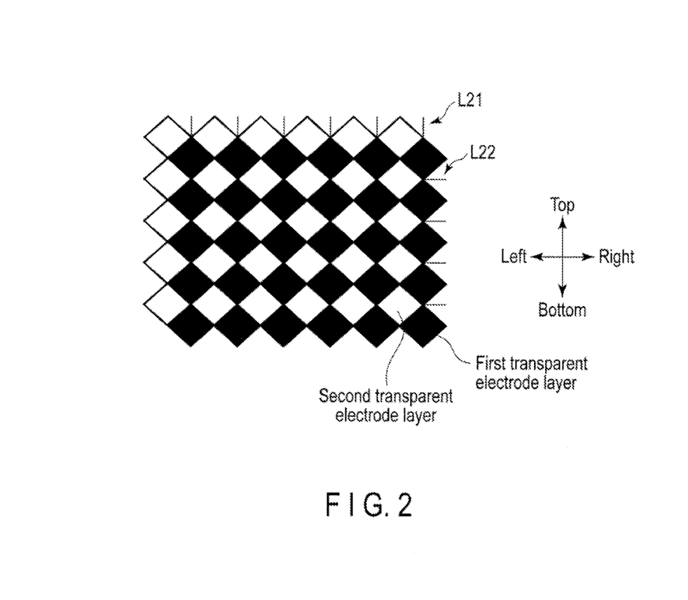

The active area 11 is an area configured to receive input from the user. The input is detected in the active area 11 by means of, for example, a projected capacitive method. Here, FIG. 2 is a schematic drawing for explaining an example of the projected capacitive method.

As shown in FIG. 2, in the projected capacitive method, a first transparent electrode layer formed in a specific first pattern and a second transparent electrode layer formed in a specific second pattern are combined together. The first pattern is formed of a plurality of rhombuses (black) arranged regularly, and from the upper side thereof, control lines L21 are drawn. The second pattern is formed of a plurality of rhombuses (white) arranged regularly, and from the right side thereof, control lines L22 are drawn. The first pattern and the second pattern are combined together to form numerous electrodes (switches) arranged in a matrix (predetermined array). According to the projected capacitive method, a large number of electrodes can be formed, and therefore it becomes possible to perform accurate multipoint detection (multi-touch operation).

The active area 11 is formed in the above-described manner. This structure enables the communication device 100, when the user touches the active area 11 corresponding to a button displayed on the liquid crystal panel 30 (see FIG. 3, which will be described later) with his or her finger or the like, to receive the user's input (instruction) of the button.

The control board 12 is provided in a position closest to the first corner C1 among the first corner C1, the second corner C2, the third corner C3 and the fourth corner C4. In other words, the first corner C1 is the closest to the control board 12 among the first corner C1, the second corner C2, the third corner C3 and the fourth corner C4. Further, the control board 12 is configured to receive input of the user via the plurality of control lines L2. More specifically, the control board 12 detects a position in the active area 11 (touchpanel glass 10) touched by the user based on the voltage change of the respective control lines L2.

The plurality of control lines L2 are connected to the respective electrodes and arranged in such a manner as to circumvent the active area 11. Further, control lines L2 are laid in such a manner as to make the distance between the respective electrodes and the control board 12 as short as possible.

Next, the wiring of control lines L2 will be described more specifically. Note that FIG. 1 illustrates only control line L1 among control lines L2 which is laid farthest from the active area 11.

On one side of the upper side of the active area 11, the plurality of control lines L21 are connected respectively to the electrodes, extended in the direction of the third corner C3, and connected to the control board 12 while circumventing the active area 11. More specifically, control lines L21 drawn above the active area 11 from the electrodes are bent and extended to the right edge (see L1a). Control lines L21 extended to the right edge are further bent and extended downward (see L1b). Still further, on the right-hand side of the active area 11, control lines L22 extended from the respective electrodes to the right-hand side are bent at right angles and extended downward. Note that control lines L22 are laid on the side of the active area 11 such that control lines L22 are closer than control lines L21 to the active area 11. Here, the above-described control lines L2 are composed of the combination of control lines L21 and control lines L22. Control lines L2 extended downward are bent at right angles and extended to the left after passing through a position at the lower edge of the active area 11 (see L1c). Further, control lines L2 are, at respective predetermined distances, bent at right angles downward and extended to connect to the control board 12 (see L1d).

Further, a predetermined wiring width is provided to control lines L2 so as to be arranged at predetermined intervals. In this way, it is possible to prevent interference from other control lines.

Since the control lines are arranged in the above-described manner, the number of control lines L21 crossing the one side on the upper side of the active area 11 at the second corner C2 is smaller than the number of the control lines L2 crossing the one side at the third corner C3. Further, on the one side on the upper side of the active area 11, the vertical wiring width of control lines L21 increases from the left to the right as the number of control lines 21 increases.

The input interface 13 is, for example, a key configured to open a menu screen for the user to execute various functions of the communication device 100. In the vicinity of the input interface 13, a control line is provided to transmit a command from the input interface 13 (omitted in the drawing). Therefore, as described above, control lines L2 are connected to the control board 12 in such a manner as to avoid the vicinity of the input interface 13. Note that the input interface 13 may be assigned with a different function.

The antenna unit 14 performs wireless communication with an external device. Further, the antenna unit 14 is provided in a position closest to the second corner C2 among the first corner C1, the second corner C2, the third corner C3 and the fourth corner C4. In other words, the antenna unit 14 is provided in such position where the smallest number of control lines L2 are laid. By providing the antenna unit 14 at the edge, deterioration of the performance of the antenna can be prevented.

The wireless module 15 is connected to the antenna unit 14 in a predetermined wiring pattern (omitted in the drawing). The wireless module 15 is configured to transmit to and receive from an external device a radio signal by using the wiring pattern and the antenna unit 14. The wireless module 15 is provided with the feed cable 16.

Further, a reference symbol W1 indicates the width at the margin on the upper side of the housing 101. Width W1 at the margin is determined on the basis of the vertical size of the antenna unit 14 and the wiring width of control lines L2. Therefore, as the vertical width of the antenna unit 14 and the wiring width of control lines L2 decrease, width W1 at the margin decreases.

The feed cable 16 is configured to supply to the antenna unit 14 voltage to be used for wireless communication. Note that a reference symbol 16a indicates a feeding point 16a of the feed cable 16.

At the second corner C2 provided with the antenna 14, the feeding point 16a is provided in such a position where a distance W10 from a side of the housing 101 parallel to a side of the active area 11 not adjacent to the antenna unit 14, that is, a side on the left side of the housing 101 is a ¼ wavelength of a predetermined frequency band (for example, 700 MHz) or less. Further, it is preferable that the distance W10 be a ⅛ wavelength of the above-described predetermined frequency band or less. By providing the feeding point 16a in such a position, it becomes possible to improve the performance of the antenna and also to make a contribution to the development of a high-performance antenna.

Next, the structure of the antenna unit 14 will be described. FIG. 3 is a sectional view taken along A-A of FIG. 1. In FIG. 3, the user side indicates a side on which the use inputs an instruction to the active area 11. The inner side indicates a side opposite to the user side.

As shown in FIG. 3, the touchpanel glass 10 comprises control lines L2 drawn from the respective electrodes. Further, on the inner side, the liquid crystal panel 30 is provided. Still further, the antenna unit 14 is provided at the edge of the liquid crystal panel 30.

The antenna unit 14 comprises an antenna 31 and an antenna holder 32 configured to hold the antenna 31. The cross-section of the antenna 31 is in an L-shape. Further, the antenna 31 has such a structure that one side of the L-shape is secured to the antenna holder 32 and the end of the other side is open in the direction opposite (in FIG. 3, turned 180 degrees in the direction opposite) to the touchpanel glass 10. Hereinafter, the open end of the other side will be referred to as an open end 31a. Further, if the above-described structure is put differently, the open end 31a is extending in the thickness direction of the communication device 100 and open in a direction away from the surface on which control lines L2 are arranged. The antenna holder 32 has such a structure that one end is secured to a part of the liquid crystal panel 30 or the housing 101 and the other end is secured to the antenna 31. Between the antenna 31 and the touchpanel glass 10, the feeding point 16a of the feed cable 16 is provided.

The communication device 100 having the above-described structure comprises the antenna unit 14 in a position away from the position where the control board 12 is provided. More specifically, the antenna 31 is provided in a position closest to the second corner C2 among the first corner C1, the second corner C2, the third corner C3 and the fourth corner C4. Therefore, it is possible to prevent radio waves emitted from the antenna 31 from being absorbed by control lines L2. In this way, the communication device 100 can prevent the deterioration of the performance of the antenna unit 14.

Further, the smallest number of control lines L2 are arranged at the second corner C2 where the antenna 31 is provided. Therefore, the communication device 100 can reduce width W1 at the margin formed on the basis of the vertical width of the antenna unit 14 and the wiring width of control lines L2. In this way, it becomes possible to achieve improvement of the design and reduction of the size of the communication device 100.

Still further, the open end 31a of the antenna 31 is open toward the inner side with respect to the touchpanel glass 10 where control lines L2 are provided, more specifically, in the direction opposite to the surface on which control lines L2 are arranged. Therefore, it is possible to keep the open end 31a and the surface where the control lines L2 are arranged away from each other. In this way, the interference from control lines L2 can be reduced as much as possible, and the deterioration of the antenna performance of the antenna 31 can be further prevented.

### Second Embodiment

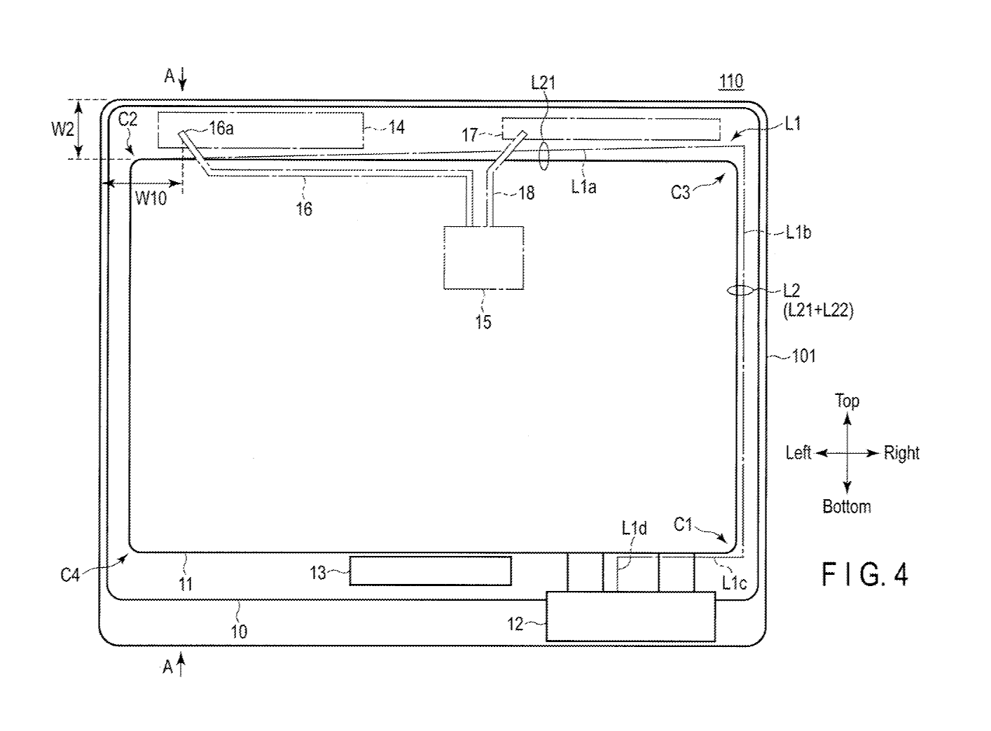

FIG. 4 is a diagram showing an example of the main structure of a communication device 110 of the second embodiment. The communication device 110 has a structure different from that of the communication device 100 in that an antenna unit 17 and a feed cable 18 are further added thereto. In the following descriptions, therefore, the added antenna unit 17 and feed cable 18 will be described. Note that portions same as those of the communication device 100 will be denoted by the same reference symbols and the detailed descriptions thereof will be omitted.

The antenna unit 17 is connected to the wireless module 15 in a predetermined wiring pattern. Further, the antenna unit 17 is provided at the third. corner C1 adjacent to the first corner C1 and to the second corner C2.

The feed cable 18 is configured to supply voltage for the antenna unit 17 to transmit and receive a wireless signal.

Here, the relationship between the antenna unit 14 and the antenna unit 17 will be described. The antenna unit 14 is a main antenna (first antenna) configured to cover a main predetermined frequency band (hereinafter referred to as a first frequency band) whereas the antenna unit 17 is a sub-antenna (second antenna) configured to operate as a diversity antenna in the first frequency band. Note that the antenna unit 17 may cover a second frequency band used in another wireless system such as a global positioning system (CPS).

Further, since the antenna unit 17 is the sub-antenna, the antenna performance may be lower than that of the main antenna, namely, the antenna unit 14. Consequently, it is possible to make the vertical width of the antenna unit 17 smaller than that of the antenna unit 14. Therefore, even if the antenna unit 17 is provided at the third corner C3 where a large number of control lines L2 are concentrated, it is still possible to make width W2 of the edge of the communication device 110 the same as width W1 at the margin of the communication device 100.

According to the communication device 110 having such a structure, an effect similar to that produced by the communication device 100 of the first embodiment can be achieved.

Still further, even comprising two antenna units, namely, the antenna units 14 and 17, the communication device 110 realizes width W2 at the margin as narrow as that of the width at the margin of the communication device 100.

Note that described in the second embodiment is a case where the communication device 110 comprises two antenna units, namely, the antenna unit 14 and the antenna unit 17, the antenna unit 14 is provided at the second corner C2, and the antenna unit 17 is provided at the third corner C3 adjacent to the first corner C1 and the second corner C2. However, the number of the antenna units is not limited to two and may be three or more. In a case where three or more antenna units are provided, at least the main antenna is provided in a position farthest from control board 12. Further, since the wiring width of the control lines L21 increases from the left to the right, the antenna units are provided in descending order of performance from the left to the right, thereby making the width of the edge the same as width W1.

Note that the first and second embodiments describe a case where the touchpanel glass 10 is formed by means of the projected capacitive method, but the touchpanel glass 10 may not be formed restrictedly in this method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a touchpanel comprising a rectangular area on which electrodes are arranged, a first corner, a second corner opposite to the first corner, a third corner, and a fourth corner opposite to the third corner;
a plurality of control lines connected to the respective electrodes and arranged to circumvent the area;
a controller provided in a position closest to the first corner among the first, second, third and fourth. corners, and configured to receive input to the electrodes via the plurality of control lines; and
an antenna provided in a position closest to the second corner among the first, second, third and fourth corners.

2. The communication device of claim 1, wherein the area comprises a first side and the first side comprises the second corner and the third corner, and
the plurality of control lines connect to the electrodes on the first side, extend in a direction of the third corner, and connect to the controller.

3. The communication device of claim 2, wherein the number of the control lines crossing the first side at the second corner is smaller than the number of the control lines crossing the first side at the third corner.

4. The communication device of claim 1, wherein the control lines are arranged to circumvent the area to take the shortest course from the electrodes to the controller.

5. The communication device of claim 4, wherein the position in which the antenna is provided is a position where the number of the control lines is the smallest.

6. communication device of claim 1, wherein an open end of the antenna is extending in a thickness direction of the communication device and open in a direction away from a surface on which the control lines are arranged.

7. The communication device of claim 2, further comprising a power cable configured to supply voltage to the antenna, wherein
a feeding point of the power cable is in a position at the second corner provided with the antenna where a distance from a side of a housing parallel to a side of the area not adjacent to the antenna is a ¼ wavelength of a predetermined frequency set to the antenna.

8. The communication device of claim 1, further comprising:
a wireless circuit configured to transmit and receive a wireless signal with the antenna; and
a sub-antenna connected to the wireless circuit.

9. The ccnmunication device of claim 8, wherein the sub-antenna is provided at the third corner adjacent to the first corner and to the second corner.
